(19) United States
(12) Patent Application Publication
(10) Pub. No.: US 2011/0209547 A1
(43) Pub. Date: Sep. 1, 2011

(54) DEVICE AND METHOD FOR THE ULTRASOUND MONITORING, MEASURING AND TRACKING OF HEAT-SEALED SEAM BETWEEN TWO METAL PARTS

(75) Inventors: Sébastien Revoirard, Givry (FR); Emmanuel Futin, Crissey (FR)

(73) Assignee: AREVA NP, Courbevoie (FR)

(21) Appl. No.: 13/059,041

(22) PCT Filed: Jul. 29, 2009
(86) PCT No.: PCT/FR2009/051522

§ 371 Date: Apr. 28, 2011

(30) Foreign Application Priority Data
Aug. 13, 2008 (FR) 08 55560

(51) Int. Cl. G01N 29/04

(52) U.S. Cl. 73/588

(57) ABSTRACT

A device for checking, measuring and monitoring by ultrasound a hot weld seam between two metal parts, of the type including at least one ultrasonic transmitter. The device includes a shoe equipped with a planar face which is suitable for being in contact with a wall of one of the two parts and includes a housing for maintaining the ultrasonic transmitter in a predetermined orientation in relation to the wall, a cooling system for cooling the ultrasonic transmitter to a temperature below its operating temperature limit, and distributor for depositing and distributing a coupling product between the base plate of the ultrasonic transmitter and the wall.

The present invention relates to a device and a method for checking, measuring and monitoring by means of ultrasound a hot weld seam between two metal parts.

### BACKGROUND

Within the context of mechanical construction and, for example, within the context of the construction of nuclear reactors, metal parts are joined together by a weld seam which is deposited by a head of a manual or automatic welding torch.

For some applications, the weld seam has to be deposited in a deep and narrow groove formed between the two parts which are to be joined together.

That is the case, for example, with the steam generators of the loops of the reactor coolant system of nuclear reactors when it is necessary to assemble, on site, two replacement steam generator parts during operations of replacing worn steam generators.

Such replacement steam generators comprise an outer casing which is formed of two parts, an upper part and a lower part, the upper part being mounted on the lower part.

The upper part of the casing is connected to the lower part by butt welding of the two tubular cylindrical parts of very large diameter, the opposing joining surfaces of which are substantially horizontal.

The two parts form between them, in the region of their joining plane, a deep and narrow weld groove which is directed horizontally.

Welding has to be carried out manually or automatically by depositing successive layers of a filler metal along the width of the groove until said groove is completely filled.

When the various successive layers of the filler metal are being deposited in the groove, weld defects can occur for various reasons.

However, the welds for joining nuclear reactor components of this type must not include any defects, or at least no defect which might progress over time during operation of the nuclear reactor.

In order to remedy this type of defect and prevent weld seams from not complying with the technical specifications, checks of the successive layers of the weld seam are carried out.

In order to check for weld defects between two metal parts it is known to use a non-destructive checking method by means of ultrasound, in which an emission source of at least one ultrasonic beam is displaced on an accessible surface of the parts in the vicinity of the weld, so that the ultrasonic emission source directs an ultrasonic beam towards the weld, in the thickness of the parts.

Echo signals which are due inter alia to defects of the weld are collected and recorded.

### SUMMARY OF THE INVENTION

However, one of the main difficulties to be overcome is the high temperature which prevails close to the weld and especially inside the groove and which is of the order of from 150 to 250° C.

In view of this constraint, the ultrasonic transmitters that are generally used lose their effectiveness and their sensitivity, so that the detection of defects is limited and the reliability of the checks is reduced.

An object of the present invention is to provide a device and a method by which, by means that are simple to carry out, a weld seam between two metal parts, and especially a weld seam within a groove formed between two metal parts, can accurately be monitored and checked at a hot temperature.

The present invention provides a device for checking, measuring and monitoring by means of ultrasound a hot weld seam between two metal parts, of the type comprising at least one ultrasonic transmitter, characterised in that it comprises a shoe equipped with a planar face suitable for being in contact with a wall of one of the two parts and comprising:

a housing for maintaining said at least one ultrasonic transmitter in a predetermined orientation in relation to said wall, said at least one ultrasonic transmitter comprising a base plate for bearing against the wall,

means for cooling said at least one ultrasonic transmitter to a temperature below its operating temperature limit, and

means for depositing and distributing a coupling product between the base plate of said at least one ultrasonic transmitter and said wall.

According to other features of the invention:

the device comprises means for longitudinally displacing said at least one ultrasonic transmitter by means of the shoe on said wall in a direction parallel to the weld seam,

the shoe has the shape of a rectangular parallelepiped,

the housing for said at least one ultrasonic transmitter is located substantially in the centre of the shoe,

the cooling means comprise at least one system of channels for circulating a fluid, which system is formed in the shoe and is connected to an inlet and an outlet for said fluid,

the cooling means comprise two systems of channels for circulating a fluid, which systems are formed in the shoe, said systems being arranged on either side of the housing and being connected to an inlet and an outlet for said fluid,

the means for depositing and distributing the coupling product comprise orifices which open at the planar face of the shoe and are connected to means for supplying said coupling product through channels formed in the shoe, and

the device comprises means for removing the coupling product that has been deposited on said wall and for cleaning the wall after the passage of the shoe.

The present invention also provides a method for checking, measuring and monitoring by means of ultrasound a hot weld seam between two metal parts by means of a device as defined hereinbefore, characterised in that it comprises the following steps:

the shoe is placed on the wall of one of the two parts by applying the planar face of the shoe to said wall,

the ultrasonic transmitter is cooled by circulating the cooling fluid in said at least one system of channels,

the coupling product is deposited on the wall through the orifices formed in the planar face of the shoe, and the coupling product is distributed between the base plate of the ultrasonic transmitter and said wall, and

the ultrasonic transmitter is displaced longitudinally and parallel to the weld seam by means of the shoe in order to carry out checking, measuring and monitoring of the weld seam.

### BRIEF DESCRIPTION OF THE DRAWINGS

Other features and advantages of the invention will become apparent from reading the description which follows, which is given by way of example and with reference to the accompanying drawings, in which:

FIG. 1 is a vertical cutaway view, in diagrammatic form, of a groove between two parts that are to be welded and in which there has been deposited a weld seam for checking by means of a device according to the invention,

FIG. 2 is a perspective view, in diagrammatic form, of a support shoe of an ultrasonic transmitter of the device according to the invention,

FIG. 3 is a perspective bottom view, in diagrammatic form, of the shoe of FIG. 2,

FIG. 4 is a perspective cutaway view, in diagrammatic form, according to the line 4-4 of FIG. 2,

FIG. 5 is a perspective view, in diagrammatic form, of a steam generator and of an automatic welding device equipped with the checking, measuring and monitoring device according to the invention,

FIG. 6 is a view in diagrammatic form and on an enlarged scale of the automatic welding device equipped with the device according to the invention, and

FIG. 7 is a perspective view, in diagrammatic form, of an embodiment of an apparatus for supporting and displacing the device according to the invention.

### DETAILED DESCRIPTION

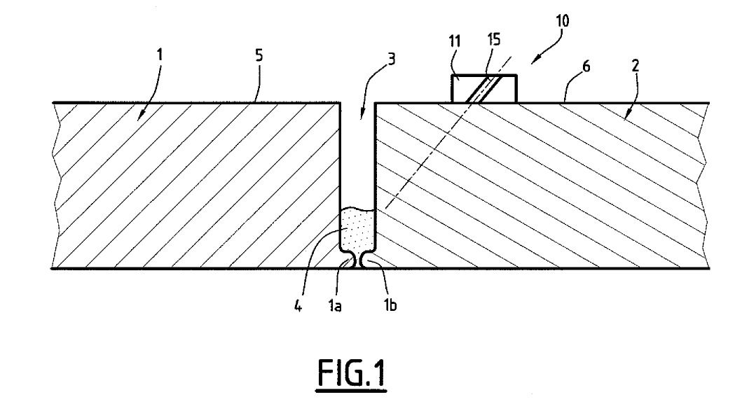

FIG. 1 shows, in diagrammatic and partial form, two parts 1 and 2 which are to be joined, which parts 1 and 2 have opposing joining surfaces which delimit between them a weld groove 3 of a precise and constant shape along the entire length or the entire periphery of the parts 1 and 2, in which a weld seam 4 is produced.

By way of example, the parts 1 and 2 have been so produced that they come to bear on one another by means of support lugs, 1a and 1b, and the groove 3 can be a narrow groove in which the side walls 5 and 6 of the parts 1 and 2 form between them a very small angle, for example less than 5°, or are substantially parallel or form between them a wide groove whose faces form an angle of from 5° to 90°.

Depending on the application, welding of the parts 1 and 2 can be carried out horizontally in the flat or vertical position or vertically by means of a head of a manual or automatic welding torch.

In addition, welding can be straight or orbital.

When the successive layers of filler metal are deposited in the groove 3, a defect, for example a localised undercut or an undercut on the side walls or a collapse of the weld seam or poor distribution of the filler metal, can occur for various reasons.

In order to correct this type of defect and prevent weld seams from not complying with the technical specifications, checks and measurements of the successive layers of the weld seam 4 are carried out by means of a device according to the invention, which is designated generally by the reference numeral 10.

The device 10 is placed in contact with one of the outside walls 5 or 6 of the parts 1 or 2, such as, for example, the outside wall 6, and is to carry out the checking, measuring and monitoring by means of ultrasound of the hot weld seam 4, either of the successive layers or of the finished weld seam.

To that end, the device 10 comprises a shoe 11 which is in the form of a metal block in the shape of a rectangular parallelepiped, for example.

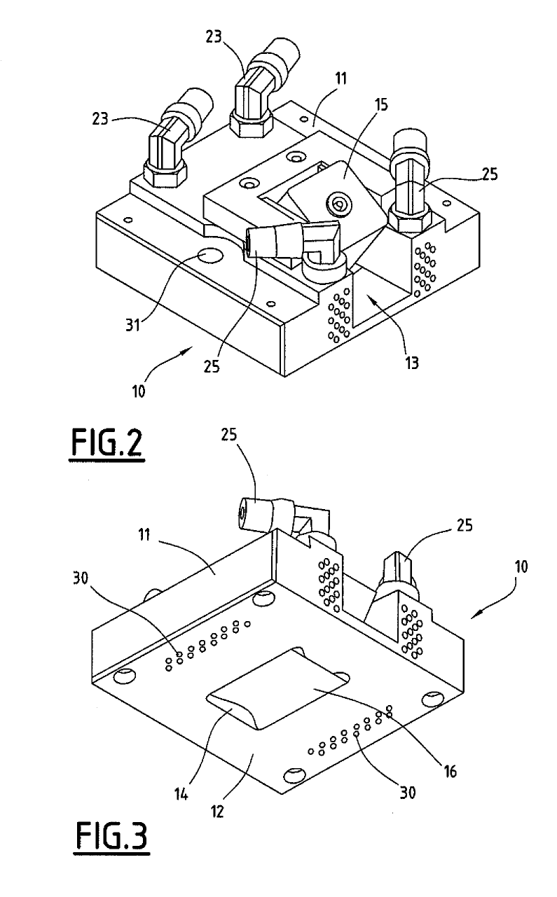

As is shown in FIGS. 2 and 3, the shoe 11 comprises a planar face 12, which is to be applied to the outside wall 6, and a housing 13 comprising an aperture 14, which opens at the planar face 12.

The housing 13 is to receive at least one ultrasonic transmitter 15 which is maintained in the housing 13 by appropriate means in such a manner that said ultrasonic transmitter 15 is positioned in a predetermined orientation in relation to the outside wall 6, as is shown diagrammatically in FIG. 1.

The housing 13 is able to receive a plurality of ultrasonic transmitters 15, one acting as emitter and another acting as receiver.

The ultrasonic transmitter 15 comprises a base plate 16 (FIG. 3) which opens in the region of the aperture 14 formed in the planar face 12 of the shoe 11.

The housing 13 for the ultrasonic transmitter 15 is located substantially in the centre of the shoe 11.

In general, the shoe 11 also comprises:

means for cooling the ultrasonic transmitter 15 to a temperature below its operating temperature limit, and

means for depositing and distributing a coupling product between the base plate 16 of the ultrasonic transmitter 15 and the outside wall 6.

The cooling means comprise at least one system 20 of channels 21 for circulating a cooling fluid; in the embodiment shown in FIGS. 2 to 4, it comprises two systems 20.

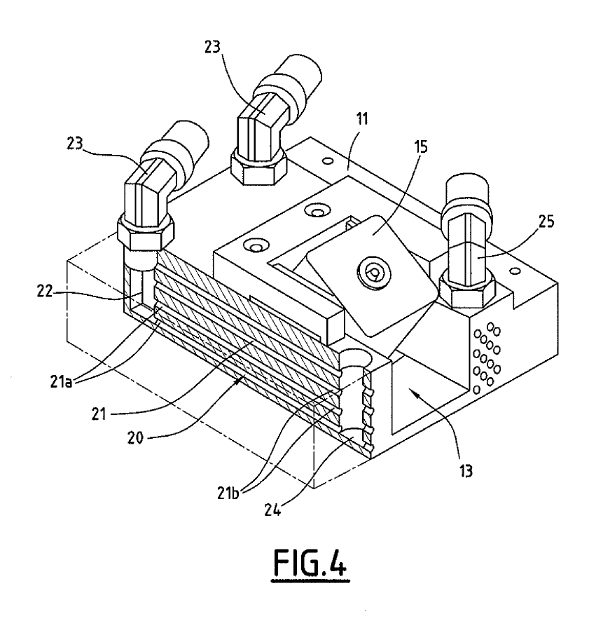

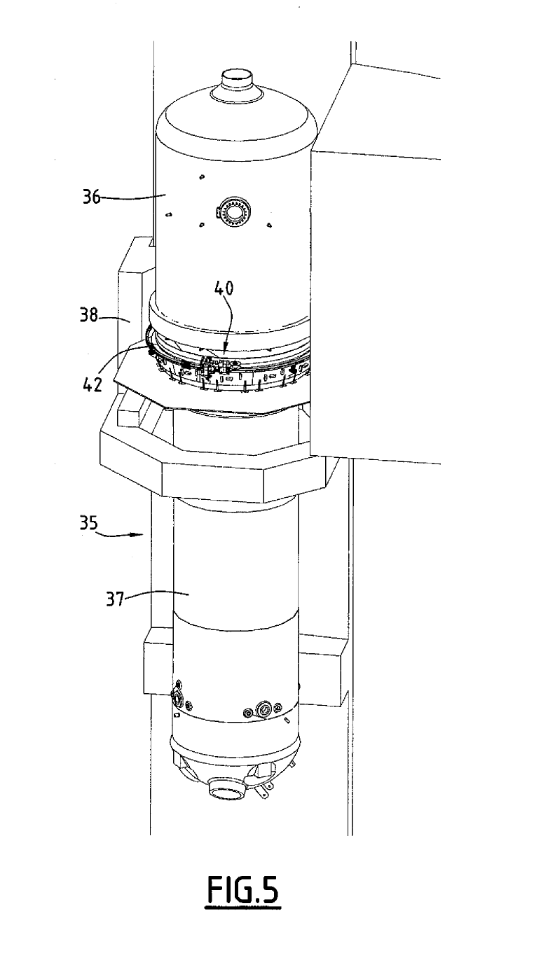

In FIG. 4, only one system 20 of channels 21 has been shown, the other system 20 of channels 21 being identical and symmetrical relative to the housing 13. Accordingly, the systems 20 are arranged on either side of the housing 13.

The channels 21 of each system 20 lead at a first end 21a into a collector 22, which is connected to a pipe 23 for supplying the cooling fluid, and at a second end 21b into a collector 24, which is connected to an outlet pipe 25 for the cooling fluid.

According to a variant, the cooling means are formed by a system of channels which are arranged around the housing 13 in order to ensure effective cooling of the ultrasonic transmitter 15.

The means or distributor for depositing and distributing the coupling product, such as, for example, a gel, comprise orifices 30 which open at the planar face 12 of the shoe 11 (FIG. 3) and are connected, by means of channels formed in the shoe 11, to an orifice 31 for supplying the coupling product.

In the embodiment shown in FIG. 3, orifices 30 are arranged on either side of the aperture 14, that is to say on either side of the base plate 16 of the ultrasonic transmitter 15.

Checking of the hot weld seam 4 at a temperature of the order of from 150 to 250° C. is carried out as follows.

The shoe 11 is first connected to the means for supplying cooling fluid and to the means for supplying coupling product.

The shoe 11 is placed on one of the outside walls close to the groove 3, such as, for example, the outside wall 6.

The cooling fluid, which is at a constant temperature of, for example, from 9 to 15° C., is circulated in the channels 21 of the systems 20 so as to cool the ultrasonic transmitter 15 in order to keep it at a temperature below its operating temperature limit and especially at a temperature below 150° C.

The shoe 11 is displaced, either manually or automatically, independently by means of a specific tool or simultaneously with the displacement of a welding torch head, and the coupling product is deposited between the base plate 16 of the ultrasonic transmitter 15 and the wall 6 as the shoe 11 is displaced.

The ultrasonic transmitter 15 is displaced longitudinally and parallel to the weld seam 4 by means of the shoe 11 so as to carry out the checking, measuring and monitoring of the seam of the weld.

Deposition of the coupling product can be carried out both during a forward check and during a reverse check by displacement of the shoe 11 in one direction or the other.

Cooling of the ultrasonic transmitter 15 enables the operation thereof to be optimised and allows reliable and effective checking and monitoring of the hot weld seam to be obtained.

After the shoe 11 has passed over the side wall 6, the surface of the side wall 6 is cleaned by an appropriate system. The system comprises, for example, a rotating brush which is itself cleaned, for example, by a fluted shaft, and this system can be coupled with a system of compressed air jets in order to ensure optimum cleaning of the surface and of the brush.

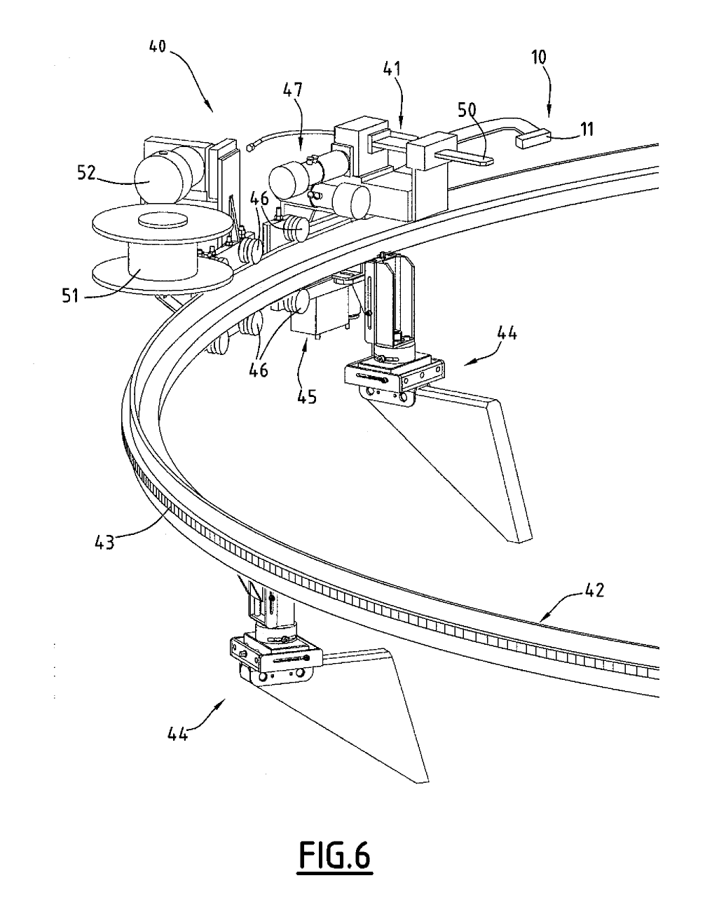

Referring now to FIGS. 5 and 6, there will be described an example of the use of the device 10 with a torch head for the automatic welding, in a groove and in the horizontal-vertical position, of two tubular cylindrical parts of large diameter of a nuclear reactor component, such as, for example, a steam generator.

FIG. 5 shows a steam generator 35, the outer casing of which is composed, in the conventional manner, of two parts, 36 and 37, which are introduced separately into a bunker, the upper part 36 of the steam generator 35 being mounted on the lower part 37, which has previously been put in place and connected to the reactor coolant system.

In order to effect joining, the two parts 36 and 37 to be joined are placed end to end so that they have opposing joining surfaces which are carefully machined in order to delimit between them a weld groove of a precise and constant form, along the entire periphery of the parts 36 and 37, along which a weld seam is produced.

The production of the weld seam between the parts 36 and 37 placed in a superposed assembly position commonly referred to as the horizontal-vertical position requires the use of a suitable welding device and of displacement and control means which allow welding operations to be carried out wholly automatically by remote control, while ensuring that the weld is of perfect quality.

Such an automatic welding device, designated as a whole by the reference numeral 40 in FIG. 6, has been described in French Patent Application No. 2 877 246.

In the present case, the automatic welding device 40 is associated with a device for checking, measuring and monitoring by means of ultrasound the hot weld seam deposited inside the groove formed between the two parts 36 and 37.

As is shown in FIG. 6, the automatic welding device designated generally by the reference numeral 40 is composed especially of a welding head 41 and a rail 42 for circulation of the welding head 41. The rail is coaxial with the part 36 and comprises a rack 43 on its outside face remote from the face facing the part 36.

The rail 42, which comprises a plurality of juxtaposed sections connected together by appropriate means of the conventional type, is fixed to the part 36 by uniformly distributed feet 44.

The displacement of the welding head 41 on the rail 42 around the parts 36 and 37 is effected by a carriage 45 which carries especially the welding head 41 and is equipped with rollers 46 arranged on the upper edge and on the lower edge of the rail 42. Displacement of the carriage 45 is effected by an electric motor, which is carried by the carriage and the output shaft of which drives in rotation a pin which meshes with the rack 43 of the rail 42.

The support assembly for the welding head 41 comprises means 47 for displacement of the welding head in the direction of the depth of the groove and also for displacement in the direction of the width of the groove.

The head of the welding torch 41 comprises a rear portion 50 which is to be introduced into the groove between the parts 36 and 37, and the head has a thickness substantially less than the width of the groove.

In the conventional manner, the welding head 41 is supplied with a filler metal wire, in which there passes an electric current in order to effect fusion thereof inside the groove by an electric arc. The filler metal wire is arranged on a storage spool 51, and a motorised device 52 allows the welding head 41 to be supplied with filler metal wire.

As is shown in FIG. 6, the head of the welding torch 41 is associated with a device 10 for checking, measuring and monitoring by means of ultrasound the hot weld seam inside the groove formed between the parts 36 and 37.

The device 10 is identical with that described hereinbefore and comprises a shoe 11 equipped with at least one ultrasonic transmitter 15. The device 10 is arranged downstream of the welding torch 41 in relation to its direction of displacement in the groove and is preferably associated with a system for cleaning the surface of the outside wall on which the shoe 11 is displaced.

The device 10 has means for vertical and horizontal displacement which are not shown in FIG. 6.

During the displacement of the shoe 11, the ultrasonic transmitter 15 is supplied with power so that it emits a beam of ultrasound waves in a given direction in order to scan the weld previously deposited in the groove.

In the case where a defect is present in an area of the weld, at a certain moment during the scanning, an echo signal that is representative of the defect is then emitted and displayed on a screen of an operating unit of the ultrasonic checking means.

During a check carried out at the same time as welding and downstream thereof, and in the case where a defect is identified, it is possible, depending on certain criteria, to alert an operator, who stops the welding and carries out corrective actions.

If the defect is considered to be minor, the operator can decide to continue with the deposition of the weld seam so that, during the second pass on the following turn, the defect will advantageously be melted without having required a stoppage and a local repair of the weld seam.

In the case of automatic welding, it is possible to send to the welding torch commands for correction of the welding parameters in order to avoid accentuating a shift towards poor quality of the weld seam, which would then no longer comply with the criteria.

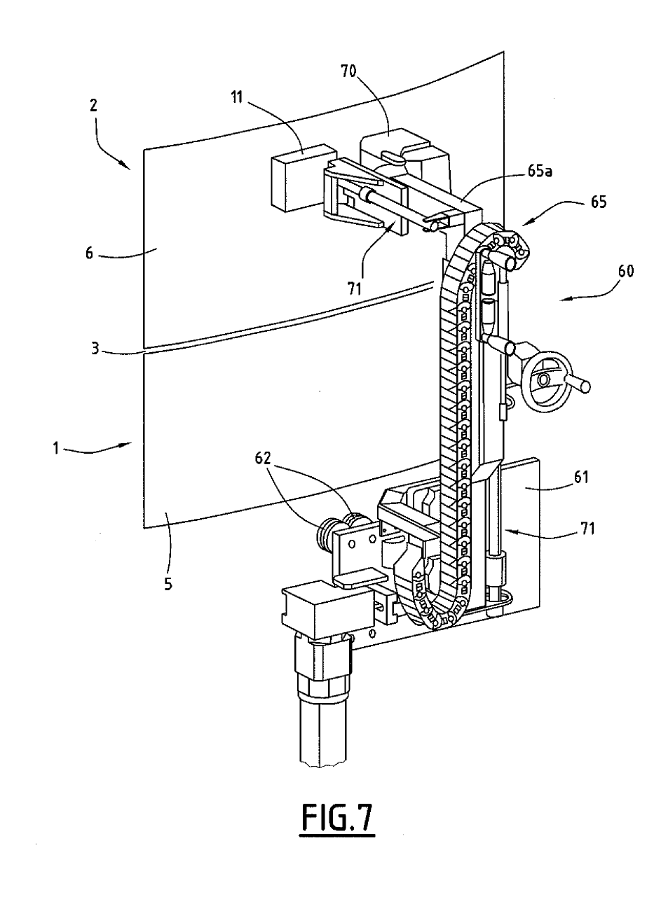

FIG. 7 shows an example of an apparatus for supporting and displacing the shoe 11 of the ultrasonic checking device 10, associated with a system 70 for cleaning the face of the part on which the device will be displaced.

The support apparatus, which is designated as a whole by the reference numeral 60, comprises a carriage 61 equipped with rollers 62 which are to cooperate with a rail, such as, for example, the rail 42 of FIG. 6.

The carriage 61 can be equipped with means for driving it on the rail 42 or can be displaced manually, or alternatively it can be associated with the welding assembly described hereinbefore.

The carriage 61 holds an assembly of arms 65 and especially a horizontal arm 65a equipped at its free end with the shoe 11 carrying said at least one ultrasonic transmitter and the cleaning system 70 allowing the previously deposited coupling product to be recovered.

The arms 65 are provided with means 71, of known type, such as, for example, jacks, screw/nut systems or any other system, for displacing the shoe 11 and the cleaning system 70 horizontally and/or vertically and also for pivoting them in order to allow the position of said shoe and of said cleaning system to be adjusted in relation to the face of the metal part on which those elements have to be positioned and displaced.

The invention is applicable not only to the ultrasonic checking of welds of nuclear reactor components but also to any component of mechanical assemblies comprising welds between parts.

What is claimed is:

1-10. (canceled)

11. A device for checking, measuring and monitoring by ultrasound a hot weld between two metal parts, the device comprising:
at least one ultrasonic transmitter;
a shoe equipped with a planar face suitable for being in contact with a wall of one of the two metal parts, the shoe comprising a housing for maintaining the at least one ultrasonic transmitter in a predetermined orientation in relation to the wall, the at least one transmitter comprising a base plate for bearing against the wall;
a cooling system for cooling the at least one ultrasonic transmitter to a temperature below an operating temperature limit of the at least one ultrasonic transmitter; and
a distributor for depositing and distributing a coupling product between the base plate of the at least one ultrasonic transmitter and the wall.

12. The device according to claim 11 wherein the shoe longitudinally displaces the at least one ultrasonic transmitter on the wall in a direction parallel to the weld seam.

13. The device according to claim 11 wherein the shoe is a rectangular parallelepiped.

14. The device according to claim 11 wherein the housing for the at least one ultrasonic transmitter is located in the center of the shoe.

15. The device according to claim 11 wherein the cooling system comprises at least one system of channels for the circulation of a fluid, the at least one system of channels being formed in the shoe and connected to an inlet and an outlet for the fluid.

16. The device according to claim 15 wherein the cooling system comprises two systems of channels for circulating the fluid, the two systems of channels being in the shoe, arranged on either side of the housing and connected to the inlet and to the outlet for the fluid.

17. The device according to claim 11 wherein the distributor for depositing and distributing the coupling product comprises orifices opening at the planar face of the shoe and connected to channels formed in the shoe.

18. The device according to claim 11 further comprising a cleaning system for removing the coupling product deposited on the wall and for cleaning the wall after the passage of the shoe.

19. A method for checking, measuring and monitoring by ultrasound a hot weld seam between two metal parts by the device according to claim 11, the method comprising the following steps:
placing a shoe on a wall of one of the two metal parts by applying a planar face of the shoe to the wall;
cooling an ultrasonic transmitter by circulating a cooling fluid in at least one system of channels;
depositing a coupling product on the wall through orifices formed on the planar face of the shoe, and the coupling product being distributed between a base plate of the ultrasonic transmitter and the wall; and
longitudinally displacing the ultrasonic transmitter parallel to the weld seam by the shoe in order to check, measure and monitor the weld seam.

20. The method according to claim 19 further comprising removing the coupling product deposited on the wall and cleaning the wall after the passage of the shoe.
